(19) United States
(12) Patent Application Publication
(10) Pub. No.: US 2016/0221434 A1
(43) Pub. Date: Aug. 4, 2016

(54) AMMONIA PRECURSOR STORAGE SYSTEM INCLUDING A SEMI-PERMEABLE MEMBRANE

(71) Applicant: PLASTIC OMNIUM ADVANCED INNOVATION AND RESEARCH, Brussels (BE)

(72) Inventors: Philippe GEORIS, Chelles (FR); Nicolas LE CLEC'H, Margny Les Compiegne (FR)

(73) Assignee: PLASTIC OMNIUM ADVANCED INNOVATION AND RESEARCH, Brussels (BE)

(21) Appl. No.: 15/017,912

(22) Filed: Feb. 8, 2016

Related U.S. Application Data
(63) Continuation of application No. 13/396,756, filed on Feb. 15, 2012, now abandoned.

(30) Foreign Application Priority Data
Feb. 22, 2011 (EP) 11155277.4

(51) Int. Cl. B60K 15/035; B60K 15/04

(52) U.S. Cl. CPC B60K 15/035; B60K 15/0406

(57) ABSTRACT

A system for storing an ammonia precursor including a tank configured to hold the ammonia precursor; a filler opening closed by a cap, the cap being removable for refilling the tank; and a semi-permeable membrane positioned within the cap. The semi-permeable membrane is configured to block liquid from the ammonia precursor and configured to allow air and vapors from the ammonia precursor to pass therethrough when the cap is closing the filler opening. When the cap is closing the filler opening, a pathway allowing a substantial amount of vapors to escape from the tank to the atmosphere is provided so that the total internal volume of the reservoir in liters divided by the flow rate in liters per hour through the membrane at 10 mbar is lower than 20 hours.

### CROSS-REFERENCE TO RELATED APPLICATIONS

This application is a continuation application of U.S. Ser. No. 13/396,756, filed Feb. 15, 2012, now pending; which claims priority to European Application No 11155277.4 filed on Feb. 22, 2011, the whole content of this application being incorporated herein by reference for all purposes.

### TECHNICAL FIELD OF THE INVENTION

The present application relates to a storage system for an ammonia precursor including a semi-permeable membrane.

### BACKGROUND OF THE INVENTION

Laws governing passenger and utility vehicle emissions require, in part, a reduction of the nitrogen oxide (NOₓ) released into the atmosphere. This goal may be achieved by the SCR (Selective Catalytic Reduction) process, which serves to reduce the nitrogen oxides by injecting a reducing agent, generally ammonia, into the exhaust line. This ammonia may be produced by the thermolytic decomposition of a solution of an ammonia precursor whereof the concentration may be eutectic. Such an ammonia precursor can be a urea solution, for example.

With the SCR process, the high NOₓ releases produced in the engine during combustion at optimized efficiency are treated at the engine outlet in a catalyst. This treatment requires the use of the reducing agent in a precise concentration and in an extreme quality. The solution is thus accurately metered and injected into the exhaust gas stream, where it is hydrolysed, before converting the nitrogen oxide (NOₓ) to nitrogen (N₂) and water (H₂O).

For this purpose, vehicles may be equipped with a tank containing an aqueous urea solution and with a device for metering and injecting the desired quantity of additive into the exhaust line.

Besides being able to be filled, urea tanks must generally be ventilated when they reach a certain threshold pressure and/or vacuum. Accordingly, urea tanks can be equipped with pressure control valving, such as a double valve system (i.e., a system incorporating two (2) valve elements: one capable of taking care of over pressure situations and one capable of taking care of under pressure (vacuum) situations) to facilitate the venting. Utilizing a double valve system limits excess pressure in the tank which can be caused by an increase in temperature, freezing of the urea solution, or a decrease in atmospheric pressure. Utilizing a double valve system also limits excess depression in the tank caused by a reduction in temperature, thawing of the urea solution, an increase in the atmospheric pressure, or consumption of the urea solution.

The Applicant found out that a venting valve including a moving part can be blocked by the crystallization of the urea solution after the zone of sealing of the valve becomes wet from the urea solution. Thus, the valve can be difficult to open or close, resulting in poor pressure control.

The Applicant hence had the idea to replace such a valve with a semi-permeable membrane configured to block liquid from the ammonia precursor and configured to allow air and vapors from the ammonia precursor to pass there through. Preferably, choice is made of a specific membrane which is not affected in its performances by urea crystallisation.

However, when such a membrane is used as venting device, it is advantageously combined with an OFP (Over Filling Prevention) device (since generally, the pressure build up will be very limited, typically: of about 10 mbar only, so that the filler nozzle will not automatically shut off at the end of refilling) which adds to the cost and technical complexity (resistance to crystallization, process, packaging) of the system.

In order to avoid the use of such a device, the Applicant had the idea to include said membrane inside the cap of the filler pipe so that during filling, the tank is not ventilated and pressure can build up. Besides, by doing so, the venting function becomes serviceable (easy to replace when damaged) which is highly appreciated by the car manufacturers since the complete tank does not have to be changed in case of venting component failure.

The use of such a venting membrane is known for fuel tanks (see for instance US 2006/0096258 and US 2007/0175514) but up till now, it has never been used (or suggested for use) on SCR tanks, namely because membranes compatible with urea applications are not common on the market.

It is worth noting that the latter (US 2007/0175514) proposes to incorporate the membrane into the filler pipe cap but since said cap is provided with a cover having a small size venting hole providing only a limited communication between the inside and the outside of the tank, a substantial amount of pressure build-up occurs in service, requiring mechanical reinforcing means (over sizing of wall thickness, specific shapes & reinforcements etc.) adding again cost (and weight) to the system.

### SUMMARY OF THE INVENTION

The present invention aims at providing a system for storing an ammonia precursor which allows venting in service while still having a reduced weight, being robust, cheap and easily serviceable.

Therefore, the present invention concerns a system for storing an ammonia precursor, comprising:
a tank configured to hold the ammonia precursor,
a filler opening closed by a cap, said cap being removable for refilling the tank; and
a semi-permeable membrane positioned within said cap,
   wherein the semi-permeable membrane is configured to block liquid from the ammonia precursor and configured to allow air and vapors from the ammonia precursor to pass there through when the cap is closing the filler opening, and wherein when the cap is closing the filler opening, a pathway allowing a substantial amount of vapors to escape from the tank to the atmosphere is provided so that the total internal volume of the reservoir (1) divided by the flow rate through the membrane at 10 mbar (1/h) is lower than 20 h.

The system of the invention comprises a tank (storage volume delimited by a wall), preferably made of plastic material (polyethylene for instance), and which comprises a filler opening provided with a cap integrating a semi-permeable membrane.

The filler opening may be a mere opening in the tank wall i.e. a mere passageway, or it may be the upper part of a filler pipe (which is generally the case in practice). Generally, the cap capable of closing said opening comprises a device allowing it to be fixed on said opening. A portion in relief on the cap cooperating with a corresponding portion in relief on the filler pipe gives good results. In practice, corresponding threaded portions on the cap and on the filler pipe are convenient since generally, filler pipe and cap are molded from plastic material.

Hence, according to a preferred embodiment of the invention, the tank is made of plastic material and comprises a filler pipe comprising the filler opening, the filler pipe and the cap being molded from plastic material and comprising corresponding threaded portions.

According to the invention, the semi-permeable membrane is configured to block liquid but to allow ammonia vapors to pass there through without any substantial pressure build-up. This means that preferably, the semi-permeable membrane is configured to allow no more than 100 mbar over pressure, more preferably not more than 50 mbar or even more preferably: not more than 10 mbar overpressure will occur in service.

To that end, generally, a pathway allowing a substantial amount of vapors to escape from the tank to the atmosphere must be provided. In practice, said pathway is sized according the following rule: the total internal volume of the reservoir (1) divided by the flow rate through the membrane at 10 mbar (1/h) is lower than 20 h, preferably lower than 15 h and even more preferably, lower than 10 h.

The semi-permeable membrane can comprise a suitable textile or other known porous material. For example, the semi-permeable membrane may be comprised of a Polytetrafluoroethylene (PTFE) based material (or may comprise sintered PTFE) or another perfluorated polymer. However, alternative materials that are hydrophobic, or water repellent, may be suitable, like for instance membranes or fabrics available under the commercial name GORE-TEX®.

The semi-permeable membrane preferably includes openings ranging in size from 0.05 μm to 10 μm. Further, a thickness of the semi-permeable membrane is preferably from 50 μm to 250 μm. Especially membranes of the commercial type AM1XX from GORE (having opening diameter about 0.07 μm and thickness about 200 μm) give good results in practice.

In a preferred embodiment, the semi-permeable membrane is free of any non-hydrophobic material. In a preferred embodiment, the membrane is free of any material that is wetted by water or polar liquids, metal meshes, polyamide membrane, glass fiber, or glass based membrane.

Generally, according to the invention, the cap is a part comprising a body which is preferable made by injection molding a plastic material, and which preferably comprises a threaded portion (see above). This body generally is a hollow part comprising a bore defining a generally cylindrical passage which is “obturated” by the membrane (i.e. where the membrane is fixed generally substantially perpendicularly to its axis so as to occupy a complete section thereof).

The semi-permeable membrane may be fixed to the cap by welding, for example, by thermal or (ultra)sonic welding. The welding width should be large enough to ensure a proper anchoring of the membrane into the cap to prevent leakage even after ageing on vehicle. It is highly recommended to use a cross section (i.e. a kind of grid to support the membrane) in order to avoid membrane stretching over the time, especially for membranes with a diameter higher than 15 mm. For very large membranes, these are preferably supported and fixed to the support (for instance by welding) every 15 mm.

In a preferred embodiment of the invention, the cap comprises a membrane holder or kind of hollow ring (the membrane generally being circular although other shapes may be used) eventually reinforced by ribs or spokes, to which the membrane is peripherally welded, said membrane holder being in turn fixed in the body of the cap, preferably by welding as well. Preferably, said membrane holder incorporates the above mentioned membrane support for large membranes, when required.

Preferably, the cap incorporates a seal in order to obtain a leak tight fixation of the cap on the filler opening. Although this seal may have the (classical) shape of an O-ring or the like, according to a preferred embodiment of the invention, this seal is a flat, circular seal comprising small orifices. This embodiment prevents access to the membrane by the user and hence, prevents the membrane from being damaged.

In order for the seal to be able to act as such and to be compressed when the cap is mounted on the filler opening, the cap preferably comprises an undercut on which said seal can be compressed. Especially in the case the body of the cap is injection molded, this undercut may comprise a horizontal surface and hence, could provide a liquid stagnation zone below the membrane. In order to avoid that, use can be made of an inner conical surface, providing an inclined conical surface between the membrane and the undercut so that said stagnation zone is avoided. This inner conical surface can be on a ring fixed as a separate part inside the cap. Alternatively, the cap can be molded in one piece with such an inner conical surface. This solution is generally preferred on an industrial scale.

Finally, in order to protect the (membrane of) the cap during its shipping and during its mounting on the filler opening (where torsion could deform and damage the cap), it may be advantageous to use a cover, mechanically fixed on the top of the cap but in a non leak tight manner so that the required vapor pathway can be obtained. To that end, the cover preferably comprises at least one opening and even more preferably, said opening is in the shape of a slit. Advantageously, said opening is in the lateral wall of the cover so that no dust or dirt can foul the membrane.

In practice, good results are obtained with the present invention if the pressure drop through the pathway downstream of the membrane is at least 20 (preferably 15 and even more preferably, 10) times less than the pressure drop across the membrane.

As to the materials used for the parts of the system according to the invention, they are preferably:
polyethylene (and preferably HDPE or high density polyethylene) for the tank wall
polyamide (PA, like PA 6 or polycaprolactam for instance) or polyacetal also called POM (or poly-oxy-methylene) for the cap (and the cover, the case being), the former being more interesting economically speaking while the latter might be better for its chemical resistance (not only directly towards urea/ammonia corrosion but also, towards corrosion from substances issuing from the corrosion of other parts of the system, for instance, PVC parts which can release HCl).

The ammonia precursor is advantageously in aqueous solution. The invention gives good results with aqueous solutions of urea and in particular, eutectic solutions of urea and water such as solutions of AdBlue® of which the urea content is between 31.8% and 33.2% by weight and which contain around 18% of ammonia. The invention may also be applied to urea/ammonium formate mixtures in aqueous solution, sold under the trademark Denoxium® and which contain around 13% of ammonia. The latter have the advantage, with respect to urea, of only freezing from −35° C. onwards (as opposed to −11° C.), but have the disadvantages of corrosion problems linked to the release of formic acid.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a schematic view of a cut through a cap of a system according to the invention, along a vertical plane comprising the axis of said cap;

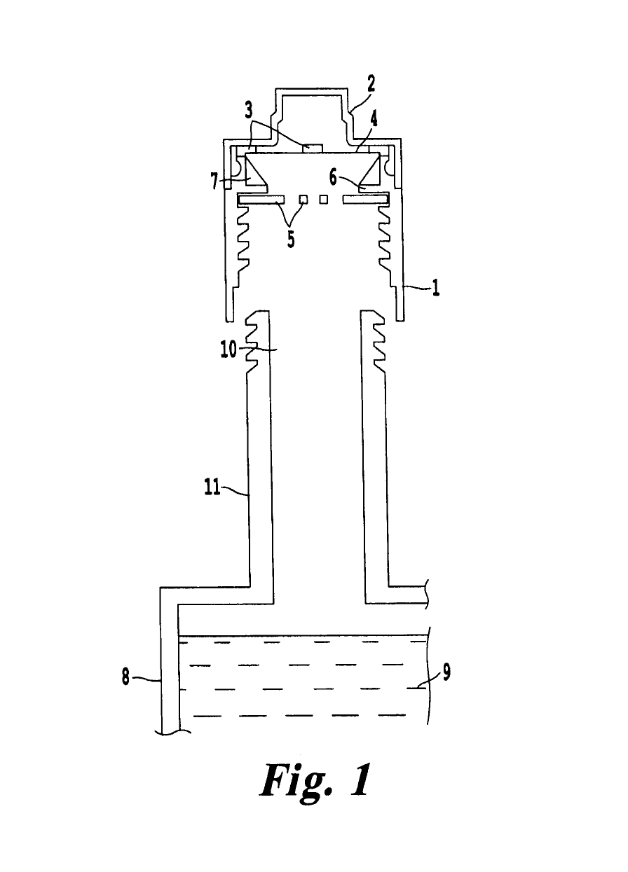

FIG. 2 shows a three dimensional (or CAD) view of said cap (cut in a half); and

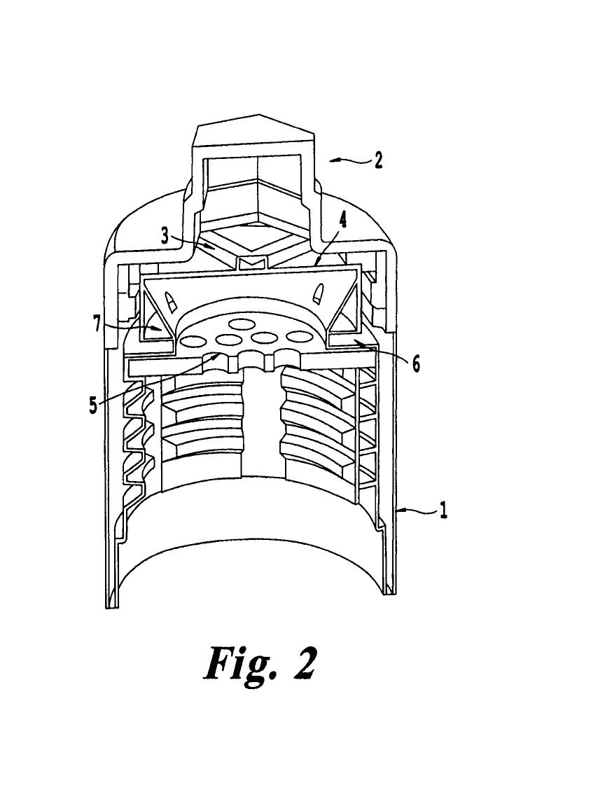

FIG. 3 shows a schematic view of a cut through a cap of a system according to the invention, along a vertical plane comprising the axis of said cap; the cap is fixed to the filler pipe.

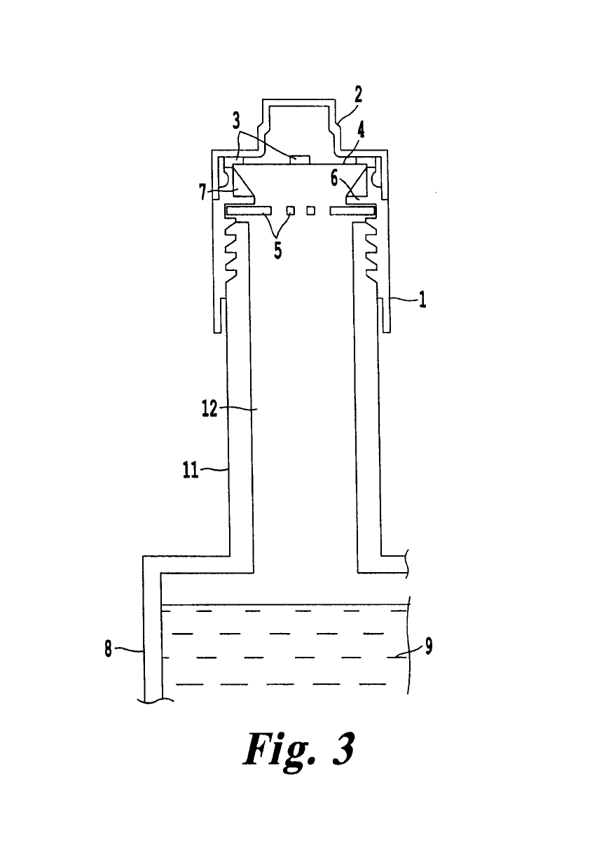

### DETAILED DESCRIPTION OF THE PREFERRED EMBODIMENTS

In the drawings, same numerical references designate identical or corresponding parts, namely:
1. a cap 1 with a threaded portion intended to be screwed on a corresponding threaded portion of a filler pipe 11 of a tank 8 storing ammonium precursor 9. A pathway 10 allows a substantial amount of vapours to escape from the tank to the atmosphere.
2. a cover 2 mechanically fixed (in any known manner like quick connect or the like) on top of said cap 1 and giving it enough mechanical strength to withstand torsion during its screwing on the filler pipe 11.
3. a membrane holder 3 having a frame in the shape of a cross acting as a support for the inner (non welded) part of the membrane 4.
4. a membrane 4 with adequate breathing properties and ammonia resistance
5. a circular flat seal 5 with circular openings.
6. an undercut 6 against which said seal 5 can be compressed when the cap 1 is mounted on the filler pipe 6.
7. a ring providing an inner conical surface inside the cap between the membrane and the undercut

Obviously, numerous modifications and variations of the present invention are possible in light of the above teachings. It is therefore to be understood that within the scope of the appended claims, the invention may be practiced otherwise than as specifically.

1-18. (canceled)

19. A vehicle system for filling an ammonia precursor tank, comprising:
a filler pipe comprising an upper part forming a filler opening;
a cap closing the filler opening, said cap being removable for refilling the ammonia precursor tank; said cap comprising a body which is a hollow part with a bore;
a semi-permeable membrane positioned within said cap such to obturate said bore, said semi-permeable membrane having a peripheral part and an inner part surrounded by the peripheral part, said semi-permeable membrane having an upstream side facing the filler opening and a downstream side, said peripheral part being welded, at the downstream side of the semi-permeable membrane, to a peripheral edge of one of the cap and a membrane holder fixed in the cap; and
a support for said inner part, said support being provided within said cap at said downstream side of the semi-permeable membrane; said support being connected to said peripheral edge,
wherein the semi-permeable membrane is configured to block liquid from the ammonia precursor tank and configured to allow air and vapors from the ammonia precursor tank to pass from the upstream side to the downstream side of the semi-permeable membrane, when the cap is closing the filler opening.

20. The vehicle system of claim 19, wherein the support is a grid.

21. The vehicle system of claim 19, wherein the support is cross shaped.

22. The vehicle system of claim 19, wherein the support is fixed to the semi-permeable membrane.

23. The vehicle system of claim 19, wherein the filler pipe and the cap are molded from plastic material and comprise corresponding threaded portions.

24. The vehicle system of claim 19, wherein the semi-permeable membrane is configured to allow no more than 100 mbar over pressure.

25. The vehicle system of claim 19, wherein the semi-permeable membrane includes a fabric made of polytetrafluoroethylene (PTFE)-based material.

26. The vehicle system of claim 19, wherein the semi-permeable membrane includes openings ranging in size from 0.05 μm to 10 μm and has a thickness ranging from 50 μm to 250 μm.

27. The vehicle system of claim 19, wherein the cap includes a flat, circular seal with small orifices, said seal being arranged in the bore, at the upstream side of the semi-permeable membrane.

28. The vehicle system of claim 19, wherein the cap comprises an undercut on which the seal can be compressed and an inner conical surface providing an inclined conical surface between the semi-permeable membrane and the undercut.

29. The vehicle system of claim 19, further including a cover mechanically fixed on the top of the cap.

30. The vehicle system of claim 29, wherein the cover includes at least one opening in the shape of a slit.

31. The vehicle system of claim 19, further including a tank connected to the filler pipe.

32. The vehicle system of claim 31, wherein an ammonia precursor is present in the tank.

33. An assembly of a filler pipe and a cap for use in a vehicle for allowing the filling of an ammonia precursor tank,
said filler pipe comprising an upper part forming a filler opening;
said cap closing the filler opening, said cap being removable for refilling the ammonia precursor tank; said cap comprising a body which is a hollow part with a bore;
wherein a semi-permeable membrane is positioned within said cap such to obturate said bore, said semi-permeable membrane having a peripheral part and an inner part surrounded by the peripheral part; said semi-permeable membrane having an upstream side facing the filler opening and a downstream side; said peripheral part being welded to a peripheral edge of the cap;
a support for said inner part, said support being provided within said cap; said support being connected to said peripheral edge, wherein
said peripheral edge and said support are provided at said downstream side of the semi-permeable membrane; and
a cover mechanically fixed on a top of the cap, facing the downstream side of the semi-permeable membrane;

34. The vehicle system of claim 33, wherein the support is a grid.

35. The vehicle system of claim 33, wherein the support is cross shaped.

36. The vehicle system of claim 33, wherein the support is fixed to the semi-permeable membrane.

37. An assembly of a filler pipe and a cap for use in a vehicle for allowing the filling of an ammonia precursor tank,
said filler pipe comprising an upper part forming a filler opening;
said cap closing the filler opening, said cap being removable for refilling the ammonia precursor tank; said cap comprising a body which is a hollow part with a bore;
wherein a semi-permeable membrane is positioned within said cap such to obturate said bore, said semi-permeable membrane having a peripheral part and an inner part surrounded by the peripheral part, said semi-permeable membrane having an upstream side facing the filler opening and a downstream side, said peripheral part being welded to one of the cap or a membrane holder fixed in the cap;
wherein the semi-permeable membrane is configured to block liquid from the ammonia precursor and configured to allow air and vapors from the ammonia precursor to pass from the upstream side to the downstream side of the semi-permeable membrane, when the cap is closing the filler opening.
